(19) United States
(12) Patent Application Publication
(10) Pub. No.: US 2005/0269944 A1
(43) Pub. Date: Dec. 8, 2005

(54) Organic electroluminescent display and fabricating method thereof

(75) Inventors: Chih-Hung Su, Hsinchu City (TW); Chao-Chin Sung, Pingtung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/005,727

(22) Filed: Dec. 7, 2004

(30) Foreign Application Priority Data
Jun. 8, 2004 (TW) 93116484

(51) Int. Cl. H01J 1/62; H01J 63/04

(52) U.S. Cl. 313/504

(57) ABSTRACT

An organic electroluminescent display at least includes an upper substrate, an organic light-emitting unit, a first protection layer, a lower substrate and several spacers. The organic light-emitting unit is formed on the upper substrate. The first protection is formed on and covered the organic light-emitting unit. A gap exists between the lower substrate and the first protection layer. The spacers are disposed between the upper substrate and the lower substrate.

This application claims the benefit of Taiwan Patent Application Serial No. 093116484, filed Jun. 8, 2004, the subject matter of which is incorporated herein by reference.

### BACKGROUND OF THE INVENTION

1. Field of the Invention

The invention relates in general to a display apparatus, and more particularly, to an organic electroluminescent display.

2. Description of the Related Art

Organic electroluminescent devices, such as organic light-emitting diode displays (OLED displays), have been popularly applied to various flat displays because such advantages of self-emissive, very thin form factor, high luminance, high luminous efficiency, high contrast, short response time, wide viewing angle, low power consumption, wide operation temperature range, and potential of flexible substrate. The OLED displays include two types: bottom emission and top emission. Because the aperture ratio of the bottom emission OLED displays is limited, the top emission OLED displays have been popularized and become main stream in the display markets.

The emissive theory of OLED is with the injection of electrons and holes from metal cathode and transparent anode respectively, after recombining within organic film the energy is then transferred into visible light. However, since the metal cathode and the organic film easily react on water, the metal cathode is oxidized and separated from the organic film if the metal cathode contacts with water moisture so that dark spots appear on the screen of the display. The area of the dark spots broadens and the numbers of the dark spots increase for a period of time. Therefore, luminance of the OLED decreases and the lifetime of the OLED is shortened.

### SUMMARY OF THE INVENTION

It is therefore an object of the invention to provide an organic electroluminescent display having an upper substrate and a lower substrate. By using spacers to define a plurality of gaps uniformly among the upper substrate, the lower substrate and the spacers, chromatism is improved. Therefore, the display quality is improved and the lifetime of the OLED is extended.

The invention achieves the above-identified object by providing an organic electroluminescent display comprising an upper substrate, an organic light-emitting unit beneath the upper substrate, a first protection layer covering the organic light-emitting unit and the upper substrate, a lower substrate disposed with respect to the upper substrate, and a plurality of spacers disposed between the upper substrate and the lower substrate.

Also, the invention achieves the above-identified object by providing an organic electroluminescent display comprising a top substrate assembly and a bottom substrate assembly. The top substrate assembly includes an upper substrate, a TFT unit formed beneath the upper substrate, a reflective electrode formed beneath the upper substrate and electrically coupled to the TFT unit, an organic light-emitting layer covering the reflective electrode, a transparent electrode covering the organic light-emitting layer, and a first protection layer covering the transparent electrode, the organic light-emitting layer and the TFT unit. The bottom substrate assembly includes an lower substrate, a color filter formed on the lower substrate, a second protection layer formed on the lower substrate and covering the color filter, and a plurality of spacers disposed between the top substrate assembly and the bottom substrate assembly.

Further, the invention achieves the above-identified object by providing a method of fabricating an organic electroluminescent display, the method comprising the steps of: (a) providing a top substrate assembly; (b) providing a bottom substrate assembly; (c) providing a plurality of spacers spread on the bottom substrate assembly or disposed beneath the top substrate assembly; (d) applying an adhesive on the border of the bottom substrate assembly; and (e) jointing the top substrate assembly and the bottom substrate assembly via the adhesive so that a plurality of gaps defined by the spacers between the top substrate assembly and the bottom substrate assembly are substantially uniform.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a cross-sectional view of a top substrate assembly of the organic electroluminescent display according to the first embodiment of the present invention;

FIG. 1B is a cross-sectional view of a bottom substrate assembly of the organic electroluminescent display according to the first embodiment of the present invention;

FIG. 1C is a cross-sectional view showing an organic electroluminescent display according to the first embodiment of the present invention;

FIG. 2 is a flow chart showing the method of fabricating the organic electroluminescent display according to the first embodiment of the present invention;

FIG. 3 is a cross-sectional view showing an organic electroluminescent display according to the second embodiment of the present invention; and

FIG. 4 is a flow chart showing the method of fabricating an organic electroluminescent display according to the second embodiment of the present invention.

### DETAILED DESCRIPTION OF THE INVENTION

### First Embodiment

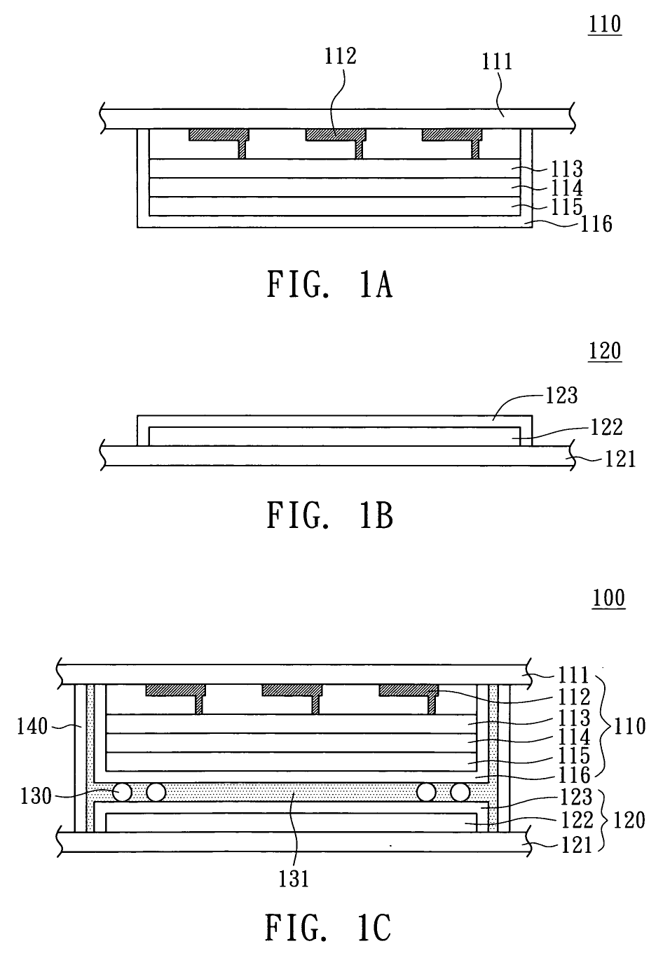

Referring to FIG. 1A to FIG. 1C, FIG. 1A is a cross-sectional view of a top substrate assembly of the organic electroluminescent display according to the first example of the preferred embodiment of the invention, FIG. 1B is a cross-sectional view of a bottom substrate assembly of the organic electroluminescent display according to the first example of the preferred embodiment of the invention, and FIG. 1C is a cross-sectional view showing the organic electroluminescent display according to the first example of the preferred embodiment of the invention. The organic electroluminescent display 100 includes a top substrate assembly 110, a bottom substrate assembly 120 and spacers 130 between the top substrate assembly 110 and the bottom substrate assembly 120. In FIG. 1A, the top substrate assembly 110 includes an upper substrate 111, a TFT unit 112, an organic light-emitting unit, and a first protection layer 116. The organic light-emitting unit includes a reflective electrode 113, an organic light-emitting layer 114, and a transparent electrode 115. The organic light-emitting layer 114 includes an electron transport layer, a light emitting layer, and a hole transport layer. The TFT unit 112 is formed beneath the upper substrate 111. The reflective electrode 113 is formed beneath the upper substrate 111 and electrically coupled to the TFT unit 112. The organic light-emitting layer 114 is formed on the reflective electrode 113. The transparent electrode 115 is form on the organic light-emitting layer 114. The first protection layer 116 is formed beneath the upper substrate 111 and covers the organic light-emitting unit and the TFT unit 112. In FIG. 1B, the bottom substrate assembly 120 includes a lower substrate 121, a color filter 122, and a second protection layer 123. The color filter 122 is formed on the lower substrate 121. The second protection layer 123 is formed on the lower substrate 121 and covers the color filter 122.

Also, the organic electroluminescent display 100 includes several granular spacers 130 evenly disposed between the first protection layer 116 and the second protection layer 123. The spacers 130 contact with the top substrate assembly 110 and the bottom substrate assembly 120 so that gaps defined by granular spacers 130 between the top substrate assembly 110 and the bottom substrate assembly 120 are substantially uniform. The diameter of the granular spacers 130 is about 1 μm to 10 μm, and the distribution density of the spacers is about 100/mm² to 1000/mm².

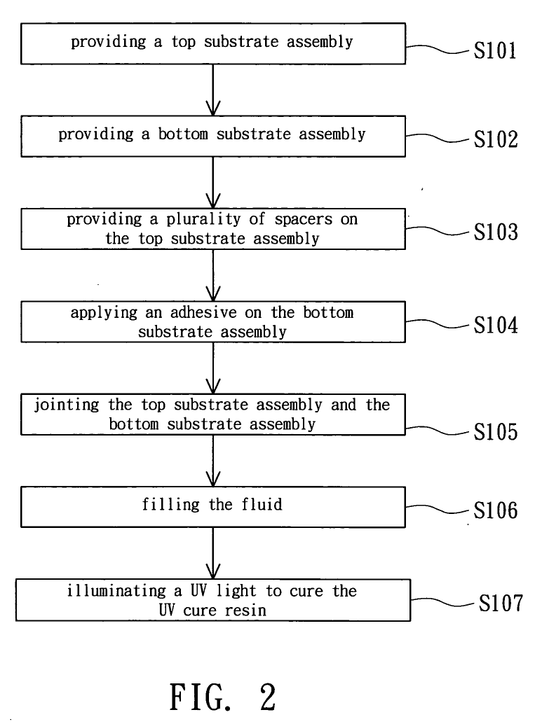

Referring to FIG. 2, it is a flow chart showing the fabricating method of the organic electroluminescent display according to the first example of the preferred embodiment of the invention. At first, in step S101, a top substrate assembly 110 is provided, and the top substrate assembly 110 includes an upper substrate 111, a TFT unit 112, an organic light-emitting unit, and a first protection layer 116. Next, in step S102, a bottom substrate assembly 120 is provided, and the bottom substrate assembly 120 includes a lower substrate 121, a color filter 122, and a second protection layer 123. Then, in step S103, the granular spacers 130 are evenly disposed on the bottom substrate assembly 120. In step S104, an adhesive 140 is applied on a border of the bottom substrate assembly 120 for jointing the top substrate assembly 110 and the bottom substrate assembly 120. In step S105, gaps are defined by the granular spacers 130, the top substrate assembly 110 and the bottom substrate assembly 120.

In step 106, gaps 130 are filled with a fluid 131 between the top substrate assembly 110 and the bottom substrate assembly 120. The refractive index of the fluid 131 is similar to that of the first protection layer 116. For example, if the first protection layer 116 is made of silicon oxide (SiO), and the fluid is preferably chosen as silicon oil, the refractive index of which is close to that of the first protection layer 116. Therefore, light deviation and energy loss generated during the light produced from the organic light-emitting layer 114 penetrating the gap can be decreased.

In step S107, the top substrate assembly 110 and the bottom substrate assembly 120 are a joint one by a UV cure resin. After that, spacers 130 are contact with both of the top substrate assembly 110 and the bottom substrate assembly 120.

The organic electroluminescent display 100 according to the first embodiment of the present invention takes a top emission OLED as the example, because lights have to follow the emitting direction of penetrating the first protection layer 116, fluid 131, spacers 130 and the bottom substrate assembly 120 in order.

### Second Embodiment

All components in the second example and in the first example are the same except the spacers, so the label of each component in the second example follows that in the first example. The organic electroluminescent display 300 in the second example includes photo spacers 330.

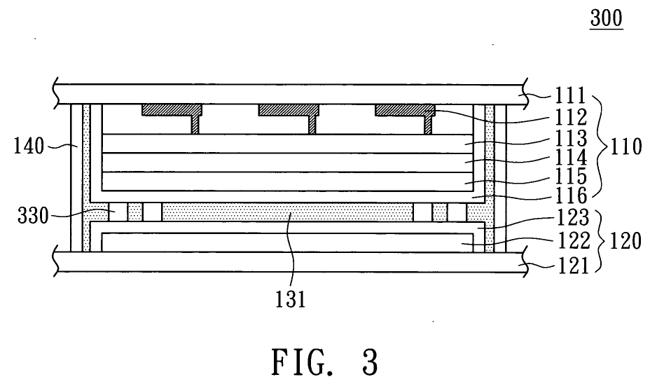

Referring to FIG. 3, it is a cross-sectional view showing the organic electroluminescent display of the preferred embodiment of the invention. In the organic electroluminescent display 300, the photo spacers 330 are formed on the first protection layer or the second protection layer. Preferably, the diameter of the spacers is about 1 μm to 10 μm, and the distribution density of the spacers is about 100/mm² to 1000/mm².

The fabricating method in the second example and in the first example is the same, except the formation of the spacers, so that label of each component in the second example follows that in the first example. Also, the organic electroluminescent display 300 in the second example includes photo spacers 330 and the formation of the photo spacers 330 will be present in step S 303 as below.

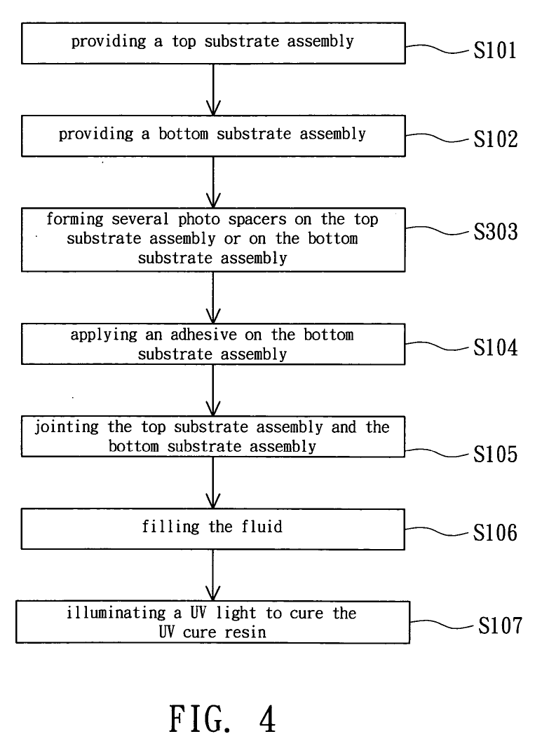

Referring to FIG. 4, it is a flow chart showing the method of fabricating the organic electroluminescent display according to the second example of the preferred embodiment of the invention. The method of fabricating the organic electroluminescent display 300 includes step S 303, forming the photo spacers 330 on the top substrate assembly 110 or on the bottom substrate assembly 120. Two ends of the photo spacers 330 separately contact to the top substrate assembly 110 and the bottom substrate assembly 120 in order to define a gap therebetween so as to accomplish the fabrication of the organic electroluminescent display 300.

To sum up, the organic electroluminescent displays of the present invention have various advantages such as prevention from water moisture, without optical path differences, and so on. By using the bottom substrate assembly and the adhesive to seal the OLED panel prevents OLED devices from water moisture and further prevents from dark spots existing on the screen of the display. Also, the gaps between the top substrate assembly 110 and the bottom substrate assembly 120 are defined by spacers so that the optical path differences can be prohibited. Therefore, the display quality is improved and the life time of the OLED is increased

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An organic electroluminescent display, comprising:
an upper substrate;
an organic light-emitting unit deposed beneath the upper substrate;
a first protection layer covering the organic light-emitting unit;
a lower substrate disposed relatively to the upper substrate; and
a plurality of spacers disposed between the upper substrate and the lower substrate.

2. The organic electroluminescent display according to claim 1, further comprising:
a color filter disposed on the lower substrate; and
a second protection layer covering the color filter and the lower substrate.

3. The organic electroluminescent display according to claim 1, further comprising an adhesive for jointing the upper substrate and the lower substrate.

4. The organic electroluminescent display according to claim 3, wherein the adhesive is a UV cure resin.

5. The organic electroluminescent display according to claim 2, further comprising an adhesive for jointing the upper substrate and the lower substrate.

6. The organic electroluminescent display according to claim 1, wherein the spacers are photo spacers.

7. The organic electroluminescent display according to claim 1, wherein the diameter of the spacers is about 1 μm to 10 μm.

8. The organic electroluminescent display according to claim 1, wherein the distribution density of the spacers is about 100/mm² to 1000/mm².

9. The organic electroluminescent display according to claim 1 further comprising a thin film transistor (TFT) disposed on the upper substrate, wherein the drain of the TFT is electrically coupled to the organic light-emitting unit.

10. The organic electroluminescent display according to claim 9, wherein the organic light-emitting unit comprises:
a transparent electrode;
an organic light-emitting layer formed on the transparent electrode; and
a reflective electrode formed on the organic light-emitting layer, wherein the reflective electrode between the upper substrate and the organic light-emitting layer is electrically coupled to the TFT.

11. An organic electroluminescent display, comprising:
a top substrate assembly comprising:
an upper substrate;
a TFT unit disposed beneath the upper substrate;
an organic light-emitting unit disposed beneath the TFT unit; and
a first protection layer disposed beneath the upper substrate and covering the organic light-emitting unit and the TFT unit;
a bottom substrate assembly comprising:
an lower substrate;
a color filter formed on the lower substrate; and
a second protection layer formed on the lower substrate and covering the color filter; and
a plurality of spacers disposed between the top substrate assembly and the bottom substrate assembly.

12. The organic electroluminescent display according to claim 11, wherein the organic light-emitting unit comprises:
a transparent electrode;
an organic light-emitting layer formed on the transparent electrode; and
a reflective electrode formed on the organic light-emitting layer, wherein the reflective electrode between the upper substrate and the organic light-emitting layer is electrically coupled to the TFT unit.

13. A method of fabricating an organic electroluminescent display, comprising:
providing a top substrate assembly;
providing a bottom substrate assembly;
providing a plurality of spacers between the top substrate assembly and the bottom substrate assembly;
applying an adhesive on the border of the bottom substrate assembly; and
jointing the top substrate assembly and the bottom substrate assembly via the adhesive to form a plurality of gaps.

14. The method according to claim 13, wherein the step of providing a top substrate assembly comprises:
providing an upper substrate;
forming an organic light-emitting unit on the upper substrate; and
forming a first protection layer covering the upper substrate and the organic light-emitting unit.

15. The method according to claim 14, wherein the step of providing a bottom substrate assembly comprises:
providing a lower substrate;
forming a color filter on the lower substrate; and
forming a second protection layer covering the color filter and the lower substrate.

16. The method according to claim 13, wherein the step of providing a plurality of spacers between the top substrate assembly and the bottom substrate assembly comprises scattering the spacers over the bottom substrate assembly.

17. The method according to claim 13, wherein the step of jointing the top substrate assembly and the bottom substrate assembly via the adhesive comprises filling the gaps with a fluid.

18. The method according to claim 14, wherein the step of providing a top substrate assembly further comprises forming a TFT unit between the organic light-emitting unit and the upper substrate, and the step of forming the TFT unit is after the step of providing the upper substrate.

19. The method according to claim 13, wherein the step of providing a plurality of spacers between the top substrate assembly and the bottom substrate assembly comprises forming the spacers on the top substrate assembly.

20. The method according to claim 13, wherein the step of providing a plurality of spacers between the top substrate assembly and the bottom substrate assembly comprises forming the spacers on the bottom substrate assembly.
